(19) United States
(12) Patent Application Publication
(10) Pub. No.: US 2006/0077791 A1
(43) Pub. Date: Apr. 13, 2006

(54) Objective lens element and optical pickup device provided with its object lens element

(75) Inventors: Hironari Takano, Osaka (JP); Michihiro Yamagata, Osaka (JP); Yasuhiro Tanaka, Nishinomiya (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/220,843

(22) Filed: Sep. 8, 2005

(30) Foreign Application Priority Data
Sep. 9, 2004 (JP) 2004-262768

(51) Int. Cl. G11B 7/00

(52) U.S. Cl. 369/44.23; 369/112.23

(57) ABSTRACT

An optical pickup device has an optical source 101 for emitting an optical beam, an objective lens element 103 positioned to receive the optical beam for focusing the beam on a medium 104, wherein a position of the optical source 101 relative to a position of the objective lens element 103 is fixed, a combined movement of the objective lens element 103 and the optical source 101 focuses the optical beam on the medium 104; and the objective lens element 103 satisfies the following condition:
−0.300≦m≦−0.200, (1) where, m is an imaging magnification.

### CROSS-REFERENCE TO RELATED APPLICATION

This application is based on application No. 2004-262768 filed in Japan on Sep. 9, 2004, the content of which is hereby incorporated by reference.

### BACKGROUND

1. Technical Field

The present invention relates generally to an optical pickup device and an objective lens element used for the optical pickup device. Particularly, the present invention relates to a fully-integrated type optical pickup device that is capable of integrally driving elements from an optical source to the objective lens element without changing a mutual relative position, and an objective lens element used for the fully-integrated type optical pickup device.

2. Description of the Background Art

Conventionally, an optical pickup device provided with an objective lens element has been used in an optical information storage device that is capable of writing information to an optical disk such as a CD medium or a DVD medium, and reading information from such optical disks and deleting information from such optical disks. As an objective lens element suitable for such optical pickup devices, an objective lens element described in Japanese Laid-open Patent Application Publication No. H07-072386 and Japanese Laid-Open Patent Application Publication No. 2003-337281 is well known.

FIG. 11 is a block diagram showing an example of a conventional optical pickup device. In FIG. 11, the conventional optical pickup device includes an optical source 1101, a hologram element 1102, a prism 1103, an objective lens element 1104, a driving unit 1106, and a photo detector 1107. In the conventional optical pickup device, a divergent optical beam which is emitted from the optical source 1101 passes through the hologram element 1102, is reflected at the surface of the prism 1103, and is focused on the optical disk 1105 by the objective lens element 1104. The optical beam reflected by the optical disk then passes through the objective lens element 1104 again, is reflected at the surface of the prism 1103, is deflected to diffraction by the hologram element 1102, and enters into the photo detector 1107.

Since the conventional optical pickup device shown in FIG. 11 employs a composition in which the optical beam from the optical source 1101 is bent by the prism 1103, it has a merit of easily achieving a thin-shape thereof in the direction vertical to the information recording side of the optical disk 1105.

Meanwhile, in the conventional optical pickup device shown in FIG. 11, the objective lens element 1104 is driven to move to both directions of the tracking direction and the focusing direction by using the driving unit 1106. From a viewpoint of the objective lens element 1104, the move of the objective lens element 1104 is equivalent to the move of the optical source 1101, relatively. Particularly, if the objective lens element 1104 is moved to the tracking direction, an optical axis of the objective lens element 1104 becomes eccentric in parallel with respect to an optical axis of the optical source 1101.

A deviation between the optical axis of the objective lens element 1104 and the optical axis of the optical source 1101 significantly influences on a spot formed on the optical disk, as an imaging magnification m of the objective lens element 1104 is increased. In the conventional optical pickup device shown in FIG. 11, in order to move the objective lens element to the tracking direction to properly perform the tracking, it is necessary to compensate for a coma aberration, a spherical aberration, and an astigmatism for the optical beam that enters into the objective lens element 1104 at the viewing angle of about ±2 degrees.

However, since the objective lens element described in the Japanese Laid-open Patent Application Publication No. H07-072386 produces astigmatism from the viewing angle of only ±0.5 degree, satisfactory performance may not be assured. Meanwhile, the objective lens element described in the Japanese Laid-Open Patent Application Publication No. 2003-337281 is designed so as to be able to compensate for the astigmatism within the viewing angle of about ±2 degrees. However, according to the objective lens element described in the Japanese Laid-Open Patent Application Publication No. 2003-337281, both of a first lens surface facing the optical source and a second lens surface facing the optical disk have a complicated aspheric surface shape so as to compensate for astigmatism. Therefore, the objective lens element described in the Japanese Laid-Open Patent Application Publication No. 2003-337281 will allow a very small tolerance in processing, resulting in difficulty in manufacturing the same.

Recently, in order to solve the problem caused by the deviation between the optical axis of the objective lens elements and the optical axis of the optical source as mentioned above, there has also been proposed a fully-integrated type optical pickup device that is capable of integrally driving elements from the optical source to the objective lens element without changing a mutual relative position. According to the fully-integrated type optical pickup device, the relative position between the objective lens element and the optical source does not change even when the objective lens element is moved in the tracking direction, thereby making it possible to reduce the burden of compensation for off-axis aberration such as coma aberration or astigmatism.

However, the distance between the object and the image of the objective lens element described in the Japanese Laid-open Patent Application Publication No. H07-072386 is short, so that when the lens element is applied to the fully-integrated type optical pickup device, a large device must be configured in the direction of the normal line of the optical disk, because of the lack of a space for inserting a prism for bending the optical beam. Therefore, there has been such a problem in the objective lens element described in the Japanese Laid-open Patent Application Publication No. H07-072386 that the lens element has been difficult to be fabricated as thin-shaped, when it has been applied to the fully-integrated type optical pickup device.

In order to make the optical pickup device small in size and weight, it is effective to use an objective lens element of a so-called finite system lens that is capable of entering the optical beam from the optical source into the objective lens element as divergent as it is without making the optical beam parallel by using a collimating lens. In the fully-integrated type optical pickup device in particular, since it is important to make the device small in size and weigh so as to reduce a load for a driving mechanism, the objective lens element may be desirably arranged as a finite system.

However, since the objective lens element system described in the Japanese Laid-Open Patent Application Publication No. 2003-337281 disclosed an infinite system objective lens element that makes a parallel light beam enter into the objective lens element, no effective suggestions for astigmatism compensation in the finite system are provided.

As described above, both of the objective lens elements described in the Japanese Laid-open Patent Application Publication No. H07-072386 and the Japanese Laid-Open Patent Application Publication No. 2003-337281 may not be an objective lens element suitable for the fully-integrated type optical pickup device being reduced in thickness by using the prism.

An object of the invention is to provide an optical pickup device, particularly a fully-integrated type optical pickup device that can achieve high performance, and is small in size and weight. Another object of the invention is to provide an objective lens element of the finite system that is suitable for a fully-integrated type optical pickup device and achieves high performance in spite of its thin-shape.

### SUMMARY

The above-mentioned purposes are achieved by an optical pickup device described in the following. An aspect of the present invention is to provide an optical pickup device, has an optical source for emitting an optical beam; an objective lens element positioned to receive the optical beam for focusing the beam on a medium, wherein, a position of the optical source relative to a position of the objective lens element is fixed; a combined movement of the objective lens element and the optical source focuses the optical beam on the medium; and the objective lens element satisfies the following condition:
−0.300≦m≦−0.200, (1)

where,

m is an imaging magnification.

According to the present invention, it is possible to provide an optical pickup device, particularly a fully-integrated type optical pickup device, with high performance and that is small in size and weight. According to the present invention, it is also possible to provide an objective lens element of the finite system that is suitable for a fully-integrated type optical pickup device and has high performance in spite of a thin-shape.

### BRIEF DESCRIPTION OF THE DRAWINGS

This and other objects and features of this invention will become clear from the following description, taken in conjunction with the preferred embodiments with reference to the accompanied drawings in which:

FIG. 1 is a view showing an optical path of an optical system of an optical pickup device common to a first to fourth embodiments;

FIG. 2 is a block diagram of the optical system of the optical pickup device common to the first to fourth embodiments;

FIG. 3 is a view of an optical path of an objective lens element according to the first embodiment;

FIG. 4 is a view of an optical path of an objective lens element according to the second embodiment;

FIG. 5 is a view of an optical path of an objective lens element according to the third embodiment;

FIG. 6 is a view of an optical path of an objective lens element according to the fourth embodiment;

FIGS. 7A to 7C are views of an aberration of the objective lens element according to the first embodiment, respectively;

FIGS. 8A to 8C are views of an aberration of the objective lens element according to the second embodiment, respectively;

FIGS. 9A to 9C are views of an aberration of the objective lens element according to the third embodiment, respectively;

FIGS. 10A to 10C are views of an aberration of the objective lens element according to the fourth embodiment, respectively;

FIG. 11 is a block diagram showing a conventional optical pickup device;

FIG. 12 is a graphic chart showing a simulation result of a relationship between an imaging magnification and an laser power in the optical pickup device; and

FIG. 13 is a graphic chart showing a simulation result of a relationship between the imaging magnification and a rim intensity in the optical pickup device.

### DESCRIPTION OF THE PREFERRED EMBODIMENTS

### First to Fourth Embodiments

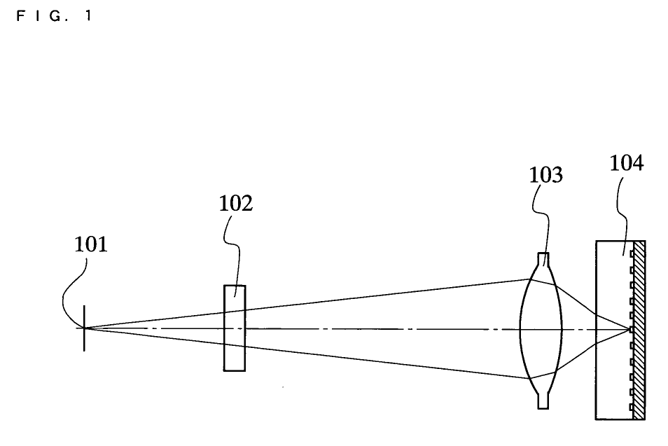

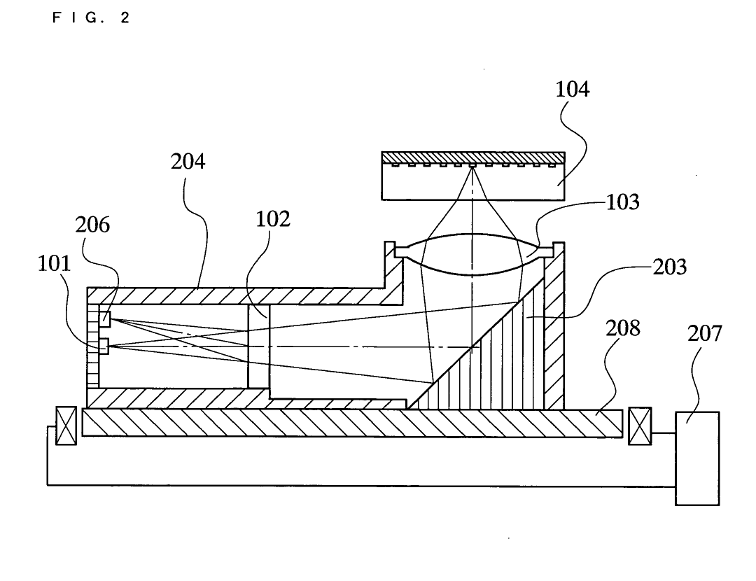

FIG. 1 is a view showing an optical path of an optical system of an optical pickup device common to a first to fourth embodiments. In addition, FIG. 2 is a block diagram of the optical system of the optical pickup device common to the first to the fourth embodiments. In FIG. 1 and FIG. 2, the optical pickup device common to each embodiment includes an optical source 101, a hologram element 102, an objective lens element 103, a prism 203, a holding unit 204, a photo detector 206, a driving unit 207, and a base 208.

The optical source 101 is a laser diode that emits a laser light beam. The hologram element 102 is designed so as to pass the optical beam from the optical source 101 and deflects the optical beam from an optical disk (medium) 104, based on, for example the polarization direction of the optical beam or the like. The prism 203 is a right triangle pole prism and a reflection film is formed on its slope. The holding unit 204 integrally holds the optical source 101, the hologram element 102, the objective lens element 103, the prism 203, and the photo detector 206 so that their mutual relative positions may not change. The base 208 fixes the holding unit 204 thereto, and is driven by the driving unit 207 in the tracking direction and in the focusing direction of the objective lens element 103. The photo detector 107 is a photo diode, and converts an incident optical beam to an electric signal to be outputted. The optical disk (medium) 104 corresponds to an optical disk such as CD, MD or DVD.

In the above composition, the divergent optical beam which is emitted from the optical source 101 passes through the hologram element 102, is reflected at the surface of the prism 103, and is focused on the optical disk 104 by the objective lens element 103. The optical beam which is reflected by the optical disk passes through the objective lens element 103 again, is reflected at the surface of the prism 203, is then deflected to diffraction by the hologram element 102, and enters into the photo detector 1107.

Thus, the optical pickup device corresponding to each of the embodiments employs a so-called fully-integrated structure where all elements from the optical source 101 to the objective lens element 103 are integrally held. For this reason, in the optical pickup device corresponding to each of the embodiments, a relative spatial relationship between the optical source 101 and the objective lens element 103 is never changed. Therefore, the objective lens element 103 can show sufficient optical performance only by compensating for the off-axis aberration within the viewing angles of ±0.5 degree.

For this reason, the load of aberration compensation for an off-axis light beam is very low for the objective lens element in each embodiment, so that complicated aspheric lens surfaces is not required. Therefore, the objective lens element of each embodiment is easy for metallic mold processing and for lens processing in manufacture and is a lens element with high productivity.

According to the optical pickup device corresponding to each embodiment, the divergent optical beam from the optical source 101 is entered into the objective lens element 103 without passing to a collimating lens. For this reason, the objective lens element 103 of each embodiment is a lens element that is used for an optical path of a finite system. Therefore, the optical pickup device corresponding to each embodiment can compactly compose the whole system.

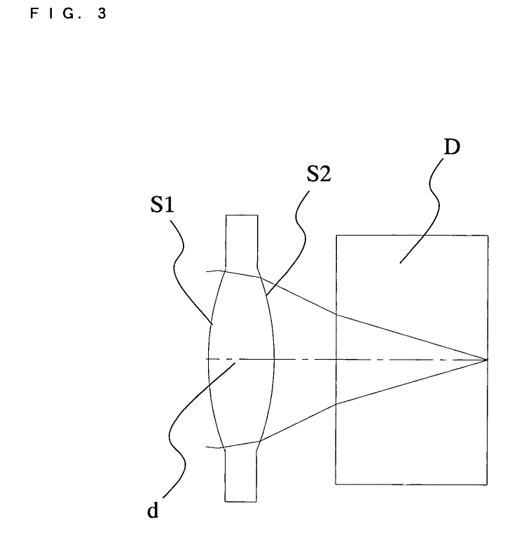

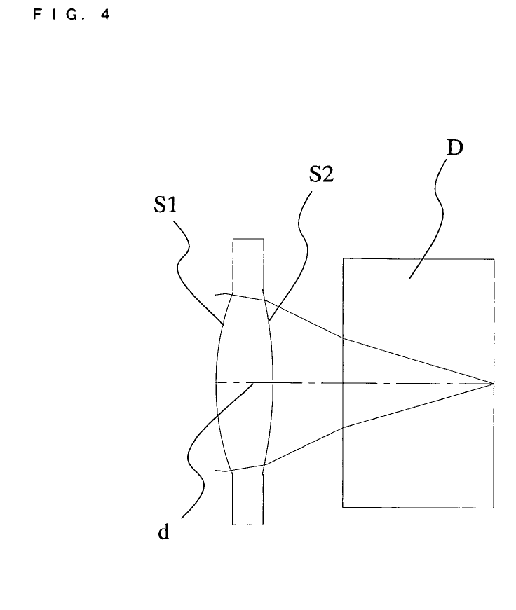

FIG. 3 is a view of the optical path of the objective lens element according to the first embodiment. FIG. 4 is a view of the optical path of the objective lens element according to the second embodiment. FIG. 5 is a view of the optical path of the objective lens element according to the third embodiment. FIG. 6 is a view of the optical path of the objective lens element according to the fourth embodiment. In each view, a first surface S1, a second surface S2, and a parallel plate D which works as a protective layer of the optical disk are arranged from the left to the right. In each view, a distance between the first surface S1 and the second surface S2 is represented as d. Each view shows an example of using a CD (Compact Disk) as the optical disk, and shows the optical path when the depth of the protective layer of the optical disk is set to 1.200 mm.

Each objective lens element according to each embodiment is a single lens element which is composed of a homogeneous medium, and both the first surface thereof facing the optical source and the second surface thereof facing the optical disk have a positive power. The objective lens element according to each embodiment is the single lens composed of the homogeneous medium, thereby making it possible to employ the composition of the optical pickup device that is easy to be manufactured and is compact in size. Moreover, since the both lens surfaces are made to have a positive power, a sufficient working distance can be reduced, thereby making it possible to employ the composition of the optical pickup device that is compact in size.

Desirably, the objective lens element according to each embodiment may satisfy following condition (1),
−0.300≦m≦−0.200, (1)

where,

m is an imaging magnification of the objective lens element.

When m exceeds the lower limit value of condition (1), the distance between the optical source and a focal point on the optical disk becomes too long, that makes it difficult to make the optical pickup device small in size. Meanwhile, when m exceeds the upper limit value of condition (1), the numerical aperture N.A. converted to an object distance at the infinite distance becomes too large, so that coma aberration to the off-axis light beam can not sufficiently be compensated, thereby making it difficult to achieve sufficient performance as the objective lens element for the optical pickup device.

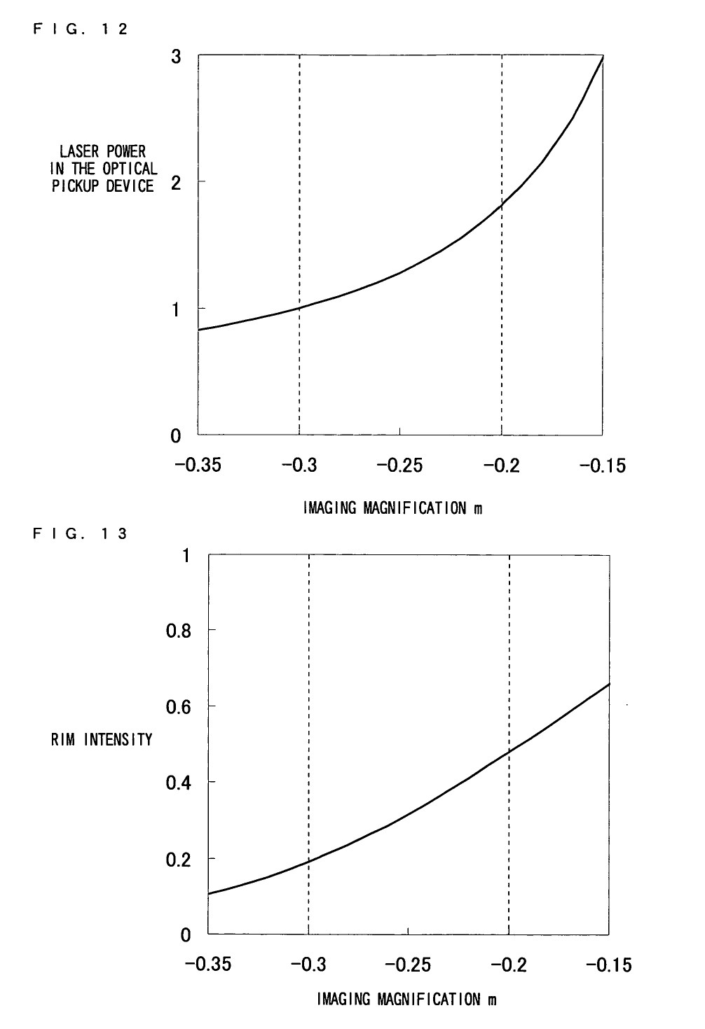

Hereinafter, the range of condition (1) will be described in further detail referring to FIGS. 12 and 13. FIG. 12 is a graphic chart showing a simulation result of a relationship between the imaging magnification and the laser power in the optical pickup device. In FIG. 12, the horizontal axis represents the imaging magnification m of the objective lens element. In addition, the vertical axis represents a value obtained by converting the laser power at the minimum level required for properly operating the optical pickup device into the laser power ratio where it is defined as 1 when the imaging magnification of the objective lens element m is −0.300. When the imaging magnification m of the objective lens element is −0.300, the value corresponds to the lower limit of condition (1). Incidentally, taking beam spread angles of common laser diodes into consideration, the simulation has been performed at a condition where the half value full angle in the perpendicular direction has been 25 degrees and the half value full angle in the horizontal direction has been 10 degrees.

As shown in the graph chart of FIG. 12, when the absolute value of the imaging magnification m is small, a large laser power is required in order to form a good spot on the optical disk. Whereas, when the laser power is increased, a problem occurs that heat generation by the laser becomes remarkable. Since the optical pickup device includes the objective lens element and many plastic components, large heat generation may desirably be avoided. Particularly, in the fully-integrated type optical pickup device, since a composition being hard to radiate heat must be employed in many cases because of restrictions from the structural components or the like, heat generation of the laser is desirable to be small as much as possible.

The upper limit of condition (1) also means a condition of specifying the maximum of the allowable laser power. In the fully-integrated type optical pickup device, assuming that the laser power is 1 when the imaging magnification of the objective lens element m is −0.300, when the laser power exceeds about 1.8, generated heat exceeds the allowable limit, thereby making it hard to perform the heat dissipation. When the laser power of about 1.8 is converted into the imaging magnification m, the value becomes −0.200. Therefore, heat generation can be limited within the allowable range by satisfying the upper limit of condition (1).

FIG. 13 is a graphic chart showing a simulation result of a relationship between the imaging magnification and the laser power intensity ratio (hereinafter, referred to as rim intensity) between the central portion and the rim portion in the direction perpendicular to the optical axis (referred to as the horizontal direction) in the optical pickup device. In FIG. 13, the horizontal axis represents the imaging magnification m of the objective lens element. The vertical axis represents the minimum level of the rim intensity required for properly operating the optical pickup device.

The rim intensity relates to a spot diameter formed by the objective lens element. When the rim intensity becomes too low, the spot diameter becomes too large to properly replay the optical disk or to write date thereto. It has been confirmed that replaying the optical disk or writing data thereto has not been able to be performed properly when the rim intensity has become 0.2 or less. When the rim intensity of 0.2 is converted into the imaging magnification m, the value becomes −0.300. The value corresponds to the lower limit of condition (1). Therefore, the proper spot diameter can be obtained by satisfying the lower limit of condition (1).

By further modifying the range of condition (1) to following condition (1)′, the above-mentioned effect can be remarkably achieved,
−0.290≦m≦−0.200 (1)′

Desirably, the objective lens element according to each embodiment satisfies following condition (2),
0.5≦d/f≦1.1, (2)

where,

d is the surface distance on the optical axis between the first surface and the second surface of the objective lens element, and

f is the focal length of the objective lens element.

Condition (2) is a condition by which astigmatism can be satisfactorily compensated. In the vicinity exceeding the lower limit value of condition (2), low-order astigmatism is reduced, but high-order astigmatism is undesirably generated. In the vicinity exceeding the upper limit value of condition (2), low-order astigmatism is undesirably increased.

By further modifying the range of condition (2) to following conditions (2)′ and (2)″, the above-mentioned effect can be remarkably achieved,
0.5≦d/f, and (2)′
d/f≦0.8 (2)″

It is desirable that the objective lens element according to each embodiment satisfies following condition (3),
−1.1≦R₁/R₂≦−0.2, (3)

where,

R₁ is the curvature radius near the optical axis of the first surface, and

R₂ is the curvature radius near the optical axis of the second surface.

Condition (3) is a condition for reducing an eccentricity error sensitivity caused by a lateral deviation between the first surface and the second surface. Particularly, the objective lens element satisfying conditional expression (3) is advantageous in terms of cost, when lens processing using molds is employed. In processing the lens using molds, a small tolerance of the lateral deviation between the mold for the first surface and the mold for the second surface will reduce the productivity. Therefore, the tolerance of the lateral deviation between the mold for the first surface and the mold for the second surface is desirably larger. When R₁/R₂ exceeds the upper or the lower limit of condition (3), coma aberration caused by the eccentric error from the lateral deviation is increased.

By further modifying the range of condition (3) to following condition (3)′, the above-mentioned effect can be remarkably achieved,
R₁/R₂≦−0.8 (3)′

Desirably, the objective lens element according to each embodiment may satisfy following condition (4),
1.5≦n, (4)

where,

n is the refractive index at the operating wavelength of the objective lens element.

Condition (4) is a condition to favorably compensate for spherical aberration and coma aberration, after conditions (1) to (3) have been satisfied. When n exceeds the lower limit value of condition (4), compensation for spherical aberration and the sine condition on coma aberration cannot be coexisted.

Desirably, the objective lens element according to each embodiment may satisfy following condition (5),
N.A.≧0.45, (5)

where,

N.A. is the numerical aperture of the objective lens element converted to the object distance at the infinite distance.

Condition (5) specifies the numerical aperture required for reading or writing information from or to the optical disk. Therefore, when this condition is not satisfied, the objective lens element cannot be used as the objective lens element for the optical pickup device.

Each of the first surface and the second surface of the objective lens element according to the first embodiment is a quadratic surface without having aspheric surface coefficients of higher than the forth order. Above-mentioned composition will desirably perform mold processing in manufacturing the lens element with mold. In this case, forming the lens surface to be spherical by setting the value of Kⱼ particularly to zero will preferably make its manufacturing easy in particular.

When each of the first surface and the second surface of the objective lens element is the quadratic surface without having aspheric surface coefficients of higher than the forth order, as is the case of the objective lens element according to the first embodiment, following condition (3a) is desirably satisfied,
−1.0≦R₁/R₂≦−0.8 (3a)

Condition (3a) is a condition to compensate for coma aberration and spherical aberration of each surface, when each of the first surface and the second surface of the objective lens element is the quadratic surface without having aspheric surface coefficients of higher than the forth order. When R₁/R₂ exceeds the lower limit value of condition (3a), the value of the offence against the sine condition (OSC) becomes negatively too large. When R₁/R₂ exceeds the upper limit value of condition (3a), the OSC value becomes positively too large. In both cases, the significantly large increase in coma aberration will lead the lens not to be applied for practical use.

The first surface of the objective lens element according to the second embodiment is the quadratic surface without having aspheric surface coefficients of higher than the forth order, and the second surface of the objective lens element of the second embodiment is the aspheric surface having aspheric surface coefficients of higher than the forth order. The above-mentioned composition will desirably balance between easiness of processing molds when the lens element is manufactured with mold, and ability of compensating for aberration by the aspheric surface. In this case, forming the lens surface to be spherical by setting the value of Kⱼ of the first surface particularly to zero will preferably make its manufacturing easy in particular.

The surface having the larger curvature radius among the first surface and the second surface of the objective lens element, is expected to be an aspherical surface satisfying following conditions (3b) and (6) to (8), as is the case of the objective lens element according to the second embodiment,
−1.0≦R₁/R₂≦−0.4, (3b)
−9.889×10⁻³≦Sag_{0.3}≦−8.172×10⁻³, (6)
−3.722×10⁻³≦Sag_{0.6}≦−3.413×10⁻³, and (7)
−8.235×10⁻³≦Sag_{1.0}≦−7.667×10⁻³, (8)

where, when the intersection of the optical axis and the lens surface, and the most outer portion of the effective diameter are defined as 0.0, and the effective diameter of 1.0, respectively,

Sag_{0.3} is a surface sag amount (mm) at the effective diameter 0.3,

Sag_{0.6} is a surface sag amount (mm) at the effective diameter 0.6, and

Sag_{1.0} is a surface sag amount (mm) at the effective diameter 1.0.

When the surface having the larger curvature radius among the first surface and the second surface of the objective lens element is made aspherical, condition (3b) is a condition to reduce the eccentricity error sensitivity caused by the lateral deviation between the first surface and the second surface. When R₁/R₂ exceeds the upper or the lower limit of condition (3b), coma aberration caused by the eccentric error from the lateral deviation is increased.

All conditions (6) to (8) represent the aspheric surface amounts to compensate for wave aberration when the surface having the larger curvature radius among the first surface and the second surface of the objective lens element is made aspherical. When those amounts exceed any one of the lower limits of conditions (6) to (8), compensation for astigmatism of the fifth order may not be executed. When those amounts exceed any one of the upper limits of conditions (6) to (8), astigmatism and coma aberration of seventh or higher order are produced. In any case, wave aberration may not be compensated.

Each of the first surface and the second surface of the objective lens element according to the third and the fourth embodiments has aspheric surface coefficients of higher than the forth order. The above-mentioned composition will be able to desirably utilize aberration compensation ability of the aspheric surface to the maximum extent.

It is desirable for the first surface and the second surface of the objective lens element to be an aspherical surface satisfying following conditions (9) to (14), as is the case of the objective lens element according to the third or the fourth embodiment,
8.383×10⁻³≦Sag_{0.3}_{_{—}}₁≦3.026×10⁻³, (9)
3.520×10⁻³≦Sag_{0.6}_{_{—}}₁≦1.340×10⁻³, (10)
7.520×10⁻³≦Sag_{1.0}_{_{—}}₁≦1.340×10⁻³, (11)
−1.893×10⁻³≦Sag_{0.3}_{_{—}}₂≦−8.383×10⁻³, (12)
−8.024×10⁻³≦Sag_{0.6}_{_{—}}₂≦−7.539×10⁻³, and (13)
−1.301×10⁻³≦Sag_{1.0}_{_{—}}₂≦−1.280×10⁻³, (14)
where, when the intersection of the optical axis and the lens surface, and the most outer portion of the effective diameter are defined as 0.0, and the effective diameter of 1.0, respectively,

Sag_{0.3}_{_{—}}₁ is the first surface sag amount (mm) at the effective diameter 0.3,

Sag_{0.6}_{_{—}}₁ is the first surface sag amount (mm) at the effective diameter 0.6,

Sag_{1.0}_{_{—}}₁ is the first surface sag amount (mm) at the effective diameter 1.0,

Sag_{0.3}_{_{—}}₂ is the second surface sag amount (mm) at the effective diameter 0.3,

Sag_{0.6}_{_{—}}₂ is the second surface sag amount (mm) at the effective diameter 0.6, and

Sag_{1.0}_{_{—}}₂ is the second surface sag amount (mm) at the effective diameter 1.0.

Conditions (9) to (14) represent the aspheric surface amounts to compensate for wave aberration when both of the first surface and the second surface of the objective lens element are made aspherical. When those amounts exceed any one of the lower limits of conditions (9) to (14), compensation for astigmatism of the fifth order may not be executed. When those amounts exceed the upper limits of conditions (9) to (14), astigmatism and coma aberration of seventh or higher order are produced. In any case, wave aberration may not be compensated.

When a wavelength λ of the optical source is within the following range, aberration compensation of the objective lens element of each embodiment is performed so that a protective layer thickness of the optical disk may correspond to about 1.2 mm.
760 nm≦λ≦810 nm (15)

When the wavelength λ of the optical source is also within the following range, aberration compensation for the objective lens element of each embodiment is performed so that it corresponds to the protective layer thickness of the optical disk of about 0.6 mm.
650 nm≦λ≦680 nm (16)

### NUMERICAL EXAMPLES

Hereinafter, numerical examples where the objective lens element according to each embodiment is embodied will be explained. A first to fourth numerical examples shown below correspond to the first to fourth embodiments described above, respectively. In a table of each numerical example, the surface shape is defined by following expression (AS).

$$X = \frac{C {ϕ}^{2}}{1 + \sqrt{1 - ( 1 + {K}_{j} ) {C}^{2} {ϕ}^{2}}} + {\sum }_{i = 2} {A}_{2 i} {ϕ}^{2 i} \\ ϕ = \sqrt{{Y}^{2} + {Z}^{2}} \\ C = \frac{1}{r} \qquad ( AS )$$

where,

X is a surface shape of the lens when the intersection of the optical axis and the lens surface is set as 0.0,

Y and Z are coordinates which are perpendicular to the X axis, respectively,

r is a curvature radius,

Kⱼ is a cone coefficient, and

A₂ᵢ is an aspheric surface coefficient.

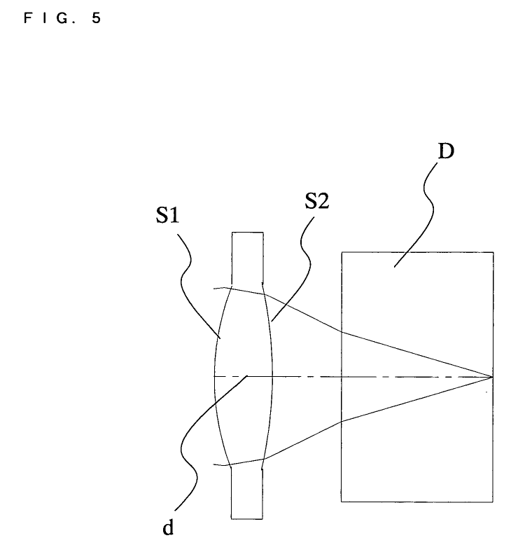

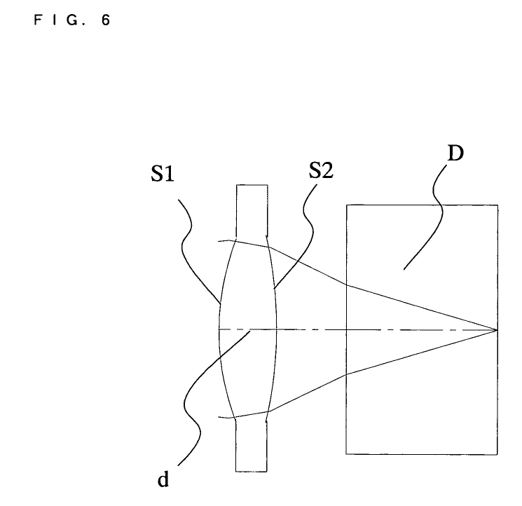

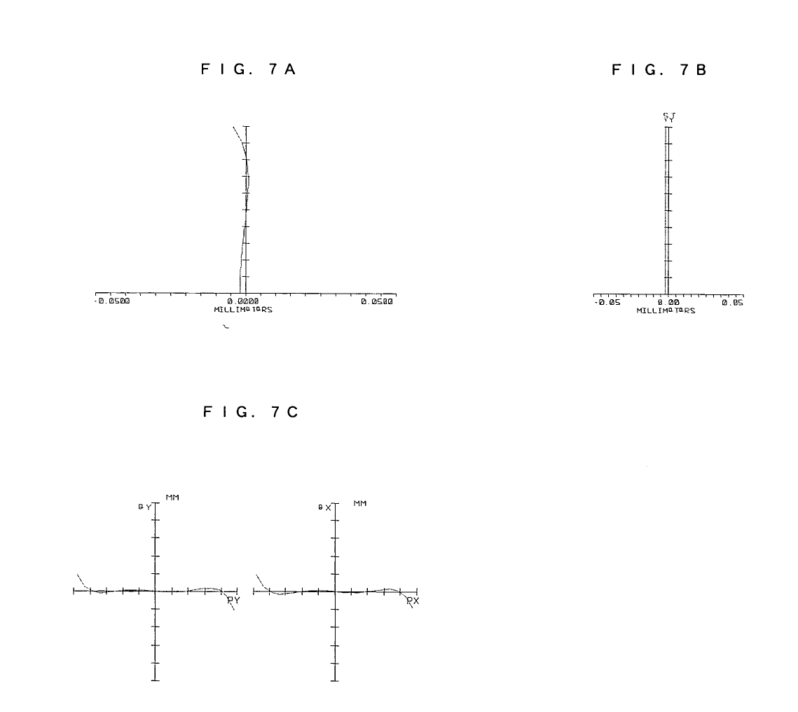

FIG. 7 to FIG. 10 are views of aberration of the objective lens elements according to the first to fourth embodiments, respectively. In each view of aberration, FIGS. 7A, 8A, 9A, and 10A show longitudinal aberration for evaluating spherical aberration, wherein the vertical axis represents an incidence height normalized by the effective diameter. FIGS. 7B, 8B, 9B, and 10B show longitudinal aberration for evaluating astigmatism, wherein the vertical axis represents a viewing angle normalized by the maximum viewing angle of 0.5 degree. FIGS. 7C, 8C, 9C, and 10C show lateral aberration for evaluating off-axis performance such as coma aberration and the astigmatism, wherein the vertical axis represents the amount of lateral aberration on an image surface.

### First Numerical Example

Table 1 shows construction data of the objective lens element according to the first numerical example. In addition, the focal length f, the working distance W.D considering the depth of the protective layer of the optical disk, the surface distance on the optical axis d between the first surface and the second surface, the refractive index n, the distance between the object and the image I/O (the distance from the optical source to the optical disk), and values of conditional expressions (1) to (3) of the objective lens element according to the first numerical example are shown together.

TABLE 1

| | FIRST SURFACE (S1) | SECOND SURFACE (S2) |
|---|---|---|
| r(mm) | 1.107710 | −1.432410 |
| Kⱼ | −1.095198 | −5.388625 |
| A₄ | 0 | 0 |
| A₆ | 0 | 0 |
| A₈ | 0 | 0 |
| A₁₀ | 0 | 0 |

f = 1.42(mm) W.D = 0.48 d = 1.31(mm)
n = 1.54 I/O = 9.54(mm)
m = −1/3.41 = −0.293 R₁/R₂ = −0.77(mm) d/f = 0.70

As can be seen from the aberration views of FIG. 7A to FIG. 7C, the objective lens element of the first numerical example shows excellent on-axis performance and off-axis performance within the viewing angle of ±0.5 degree, so that it has sufficient optical performance as the objective lens element of the fully-integrated type optical pickup device.

### Second Numerical Example

Table 2 shows construction data of the objective lens element according to the second numerical example. In addition, the focal length f, the working distance W.D considering the depth of the protective layer of the optical disk, the refractive index n, the distance between the object and the image I/O (the distance from the optical source to the optical disk), the surface distance on the optical axis d between the first surface and the second surface, and values of conditional expressions (1) to (3) of the objective lens element according to the second numerical example are shown together.

TABLE 2

| | FIRST SURFACE (S1) | SECOND SURFACE (S2) |
|---|---|---|
| r(mm) | 1.000000 | −1.542307 |
| Kⱼ | −1.095198 | −5.388625 |
| A₄ | 0 | 1.767215 × 10⁻¹ |
| A₆ | 0 | 4.146041 × 10⁻¹ |
| A₈ | 0 | −5.420348 × 10⁻¹ |
| A₁₀ | 0 | 3.079774 × 10⁻¹ |

f = 1.25(mm) W.D = 0.50 d = 0.70(mm)
n = 1.54 I/O = 8.96(mm)
m = −1/3.80 = −0.263 R₁/R₂ = −0.65(mm) d/f = 0.56

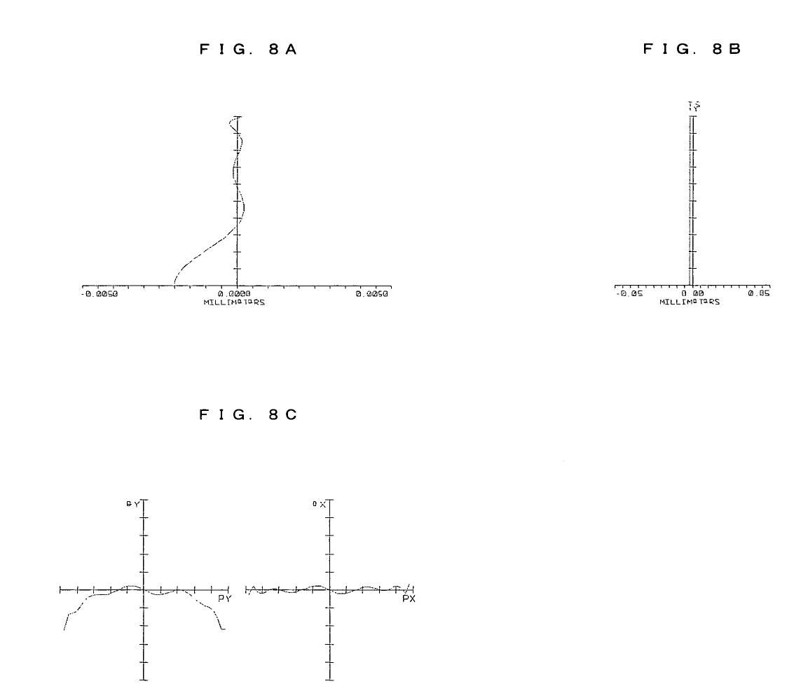

As can be seen from the aberration views of FIG. 8A to FIG. 8C, the objective lens element of the second numerical example shows excellent on-axis performance and off-axis performance within the viewing angle of ±0.5 degree, so that it has sufficient optical performance as the objective lens element of the fully-integrated type optical pickup device.

### Third Numerical Example

Table 3 shows construction data of the objective lens element according to the third numerical example. In addition, the focal length f, the working distance W.D considering the depth of the protective layer of the optical disk, the refractive index n, the distance between the object and the image I/O (the distance from the optical source to the optical disk), the surface distance on the optical axis d between the first surface and the second surface, and values of conditional expressions (1) to (3) of the objective lens element according to the third numerical example are shown together.

TABLE 3

| | FIRST SURFACE (S1) | SECOND SURFACE (S2) |
|---|---|---|
| r(mm) | 1.100000 | −1.707443 |
| Kⱼ | 8.357870 × 10⁻¹ | −5.388625 |
| A₄ | 1.373657 × 10⁻¹ | −1.056427 × 10⁻¹ |
| A₆ | −4.488310 × 10⁻¹ | −4.230535 × 10⁻² |
| A₈ | 5.450213 × 10⁻¹ | 2.657060 × 10⁻¹ |
| A₁₀ | −2.461027 × 10⁻¹ | −1.854289 × 10⁻¹ |

f = 1.35(mm) W.D = 0.72 d = 0.60(mm)
n = 1.54 I/O = 9.10(mm)
m = −1/3.38 = −0.296 R₁/R₂ = −0.607(mm) d/f = 0.44

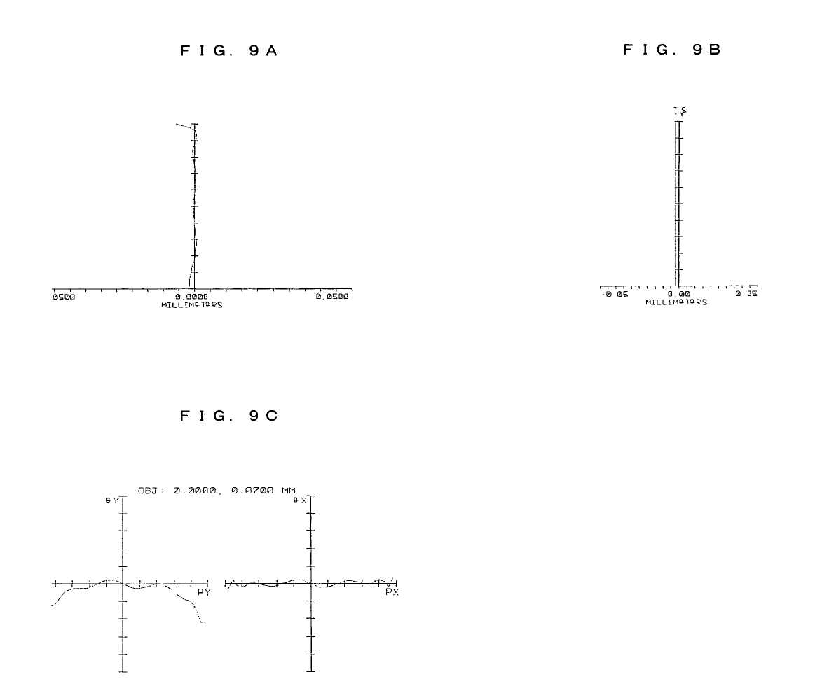

As can be seen from the aberration views of FIG. 9A to FIG. 9C, the objective lens element of the third numerical example shows excellent on-axis performance and off-axis performance within the viewing angle of ±0.5 degree, so that it has sufficient optical performance as the objective lens element of the fully-integrated type optical pickup device.

### Fourth Numerical Example

Table 4 shows construction data of the objective lens element according to the fourth numerical example. In addition, the focal length f, the working distance W.D considering the depth of the protective layer of the optical disk, the refractive index n, the distance between the object and the image I/O (the distance from the optical source to the optical disk), the surface distance on the optical axis d between the first surface and the second surface, and values of conditional expressions (1) to (3) of the objective lens element according to the fourth numerical example are shown together.

TABLE 4

| | FIRST | SECOND |
|---|---|---|
| | SURFACE | SURFACE |
| | (S1) | (S2) |
| r(mm) | 9.700000 × 10⁻¹ | −1.616913 |
| Kⱼ | 9.824228 × 10⁻¹ | −1.4925762 × 10⁻¹ |
| A₄ | 7.259180 × 10⁻³ | −2.1328369 × 10⁻¹ |
| A₆ | −4.626129 × 10⁻² | 4.962750 × 10⁻¹ |
| A₈ | −7.928514 × 10⁻² | −6.6314739 × 10⁻¹ |
| A₁₀ | −7.025567 × 10⁻² | 3.7056501 × 10⁻¹ |

f = 1.25(mm) W.D = 0.49 d = 0.70(mm)
n = 1.54 I/O = 8.94(mm)
m = −1/3.80 = −0.263 R₁/R₂ = −0.647(mm) d/f = 0.56

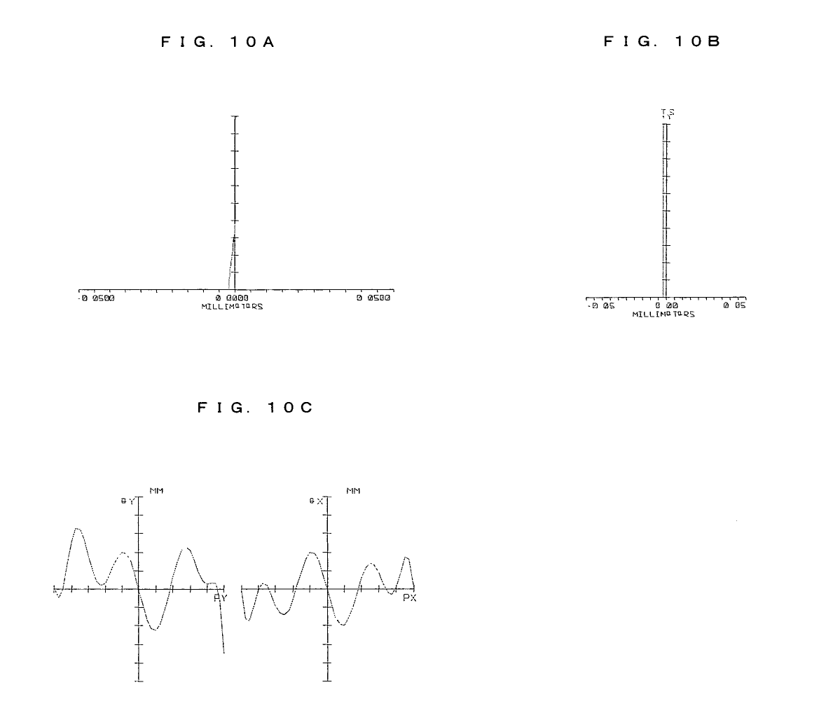

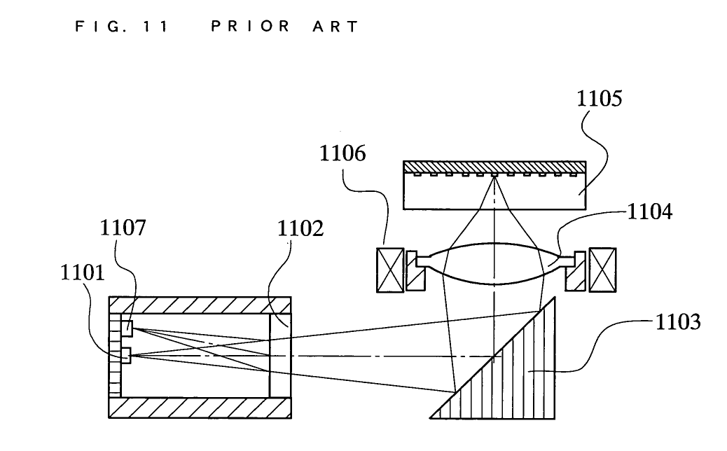

As can be seen from the aberration views of FIG. 10A to FIG. 10C, the objective lens element of the fourth numerical example shows excellent on-axis performance and off-axis performance within the viewing angle of ±0.5 degree, so that it has sufficient optical performance as the objective lens element of the fully-integrated type optical pickup device.

As described above, the objective lens element according to each numerical example has a thin shape, and shows excellent on-axis performance and off-axis performance within the viewing angle of ±0.5 degree, so that it has sufficient optical performance as the objective lens element of the fully-integrated type optical pickup device.

Therefore, by applying the objective lens element according to each numerical example to the optical pickup device, the optical pickup device that is small in size and weight can be composed.

This invention is suitable for an optical pickup device which is used for writing, deleting, or reading information to or from the optical disk, such as CD, CD-R, CD-RW, MD, DVD, DVD-R, DVD+R, DVD-RW, DVD+RW, HD-DVD, Blu-ray Disks.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. An optical pickup device, comprising:
an optical source for emitting an optical beam;
an objective lens element positioned to receive the optical beam for focusing the beam on a medium, wherein,
a position of the optical source relative to a position of the objective lens element is fixed;
a combined movement of the objective lens element and the optical source focuses the optical beam on the medium; and
the objective lens element satisfies the following condition:
−0.300≦m≦−0.200, (1)
where,
m is an imaging magnification.

2. The optical pickup device as claimed in claim 1, wherein a path of the optical beam between the optical source and objective lens element is unobstructed by a collimator.

3. The optical pickup device as claimed in claim 1, wherein the objective lens element is positioned to receive a divergent optical beam corresponding to the optical beam.

4. The optical pickup device as claimed in claim 1, wherein the objective lens element is a homogenous medium.

5. The optical pickup device as claim in claim 1, wherein:
the objective lens element is positioned such that a first surface thereof receives the optical beam and from a second surface thereof the optical beam is output, and
the first surface and the second surface each have a positive power.

6. The optical pickup device as claim in claim 1, further comprising a driver for moving the optical source and the objective lens element for adjusting the focusing of the beam on the medium.

7. The optical pickup device as claimed in claim 6, further comprising:
a base that holds the optical source and the objective lens element, wherein the driver is configured to move the base.

8. The optical pickup device as claimed in claim 1, wherein the objective lens element satisfies the following condition:
0.5≦d/f≦1.1, (2)
where,
d is a surface distance on a optical axis between a first surface and a second surface of the objective lens element, and
f is a focal length of said objective lens element.

9. The optical pickup device as claimed in claim 8, wherein the objective lens element satisfies the following conditions:
−1.1≦R₁/R₂≦−0.2, (3)
1.5≦n, and (4)
N.A.≧0.45, (5)
where,
R₁ is a curvature radius near the optical axis of a first surface of the objective lens element,
R₂ is a curvature radius near the optical axis of a second surface of the objective lens element,
n is a refractive index at an operating wavelength of objective lens element, and
N.A. is a numerical aperture of a beam output from the objective lens element.

10. The optical pickup device as claimed in claim 9, wherein:
each of the first surface and the second surface of the objective lens element is a quadratic surface having an aspheric surface coefficient less than a forth order, and the objective lens element satisfies the following condition:
−1.0≦R₁/R₂≦−0.8. (3a)

11. The optical pickup device as claimed in claim 9, wherein:
a surface having a larger curvature radius among the first surface and the second surface is an aspherical surface, and
the objective lens element satisfies following conditions:
−1.0≦R₁/R₂≦−0.4, (3b)
−9.889×10⁻³≦Sag_{0.3}≦−8.172×10⁻³, (6)
−3.722×10⁻³≦Sag_{0.6}≦−3.413×10⁻³, and (7)
−8.235×10⁻³≦Sag_{1.0}≦−7.667×10⁻³, (8)
where, when an intersection of the optical axis and the lens surface, and a position corresponding to an effective diameter are represented as the effective diameter 0.0, and the effective diameter 1.0, respectively,
Sag_{0.3} is the surface sag amount (mm) at the effective diameter 0.3,
Sag_{0.6} is the surface sag amount (mm) at the effective diameter 0.6, and
Sag_{1.0} is the surface sag amount (mm) at the effective diameter 1.0.

12. The optical pickup device as claimed in claim 9, wherein each of said first surface and said second surface is an aspheric surface, and satisfies following conditions,
8.383×10⁻³≦Sag_{0.3}_{_{—}}₁≦3.026×10⁻³, (9)
3.520×10⁻³≦Sag_{0.6}_{_{—}}₁≦1.340×10⁻³, (10)
7.520×10⁻³≦Sag_{1.0}_{_{—}}₁≦1.340×10⁻³, (11)
−1.893×10⁻³≦Sag_{0.3}_{_{—}}₂≦−8.383×10⁻³, (12)
−8.024×10⁻³≦Sag_{0.6}_{_{—}}₂≦−7.539×10⁻³, and (13)
−1.301×10⁻³≦Sag_{1.0}_{_{—}}₂≦−1.280×10⁻³, (14)
where, when an intersection of the optical axis and the lens surface, and a position corresponding to an effective diameter are represented as the effective diameter 0.0 and the effective diameter 1.0, respectively,
Sag_{0.3}_{_{—}}₁ is the first surface sag amount (mm) at the effective diameter 0.3,
Sag_{0.6}_{_{—}}₁ is the first surface sag amount (mm) at the effective diameter 0.6,
Sag_{1.0}_{_{—}}₁ is the first surface sag amount (mm) at the effective diameter 1.0,
Sag_{0.3}_{_{—}}₂ is the second surface sag amount (mm) at the effective diameter 0.3,
Sag_{0.6}_{_{—}}₂ is the second surface sag amount (mm) at the effective diameter 0.6, and
Sag_{1.0}_{_{—}}₂ is the second surface sag amount (mm) at the effective diameter 1.0.

13. The optical pickup device as claimed in claim 9, further comprising: a photo detector element that receives the optical beam focused by said objective lens element and reflected by the medium, and converts said optical beam to an electrical signal.

14. The optical pickup device as claimed in claim 9, further comprising: a reflective surface that bends the optical beam at about 90 degrees between said objective lens element and said optical source.

15. An objective lens element for converging a beam emitted by a light source on a medium, the objective lens element comprising:
a homogenous medium defined by a first surface and a second surface opposite of the first surface, wherein:
the first surface and the second surface have a positive power; and
the objective lens element satisfies the following condition:
0.5≦d/f≦1.1, (2)
where,
d is a surface distance on a optical axis between a first surface and a second surface of the objective lens element, and
f is a focal length of said objective lens element.

16. The objective lens element as claimed in claim 15, wherein the objective lens element satisfies the following conditions:
−1.1≦R₁/R₂≦−0.2, (3)
1.5≦n, and (4)
N.A.≧0.45, (5)
where,
R₁ is a curvature radius near the optical axis of a first surface of the objective lens element,
R₂ is a curvature radius near the optical axis of a second surface of the objective lens element,
n is a refractive index at an operating wavelength of objective lens element, and
N.A. is a numerical aperture of a beam output from the objective lens element.

17. The objective lens element as claimed in claim 16, wherein each of the first surface and the second surface of the objective lens element is a quadratic surface having an aspheric surface coefficient less than a forth order, and
the objective lens element satisfies the following condition:
−1.0≦R₁/R₂≦−0.8 (3a)

18. The objective lens element as claimed in claim 16, wherein a surface having a larger curvature radius among the first surface and the second surface is an aspherical surface, and
the objective lens element satisfies the following conditions:
−1.0≦R₁/R₂≦−0.4, (3b)
−9.889×10⁻³≦Sag_{0.3}≦−8.172×10⁻³, (6)
−3.722×10⁻³≦Sag_{0.6}≦−3.413×10⁻³, and (7)
−8.235×10⁻³≦Sag_{1.0}≦−7.667×10⁻³, (8)
where, when an intersection of the optical axis and the lens surface, and a position corresponding to an effective diameter are represented as the effective diameter 0.0, and the effective diameter 1.0, respectively,
Sag_{0.3} is the surface sag amount (mm) at the effective diameter 0.3,
Sag_{0.6} is the surface sag amount (mm) at the effective diameter 0.6, and
Sag_{1.0} is the surface sag amount (mm) at the effective diameter 1.0.

19. The objective lens element as claimed in claim 16, wherein each of said first surface and said second surface is an aspheric surface, and satisfies following conditions,
8.383×10⁻³≦Sag_{0.3}_{_{—}}₁≦3.026×10⁻³, (9)
3.520×10⁻³≦Sag_{0.6}_{_{—}}₁≦1.340×10⁻³, (10)
7.520×10⁻³≦Sag_{1.0}_{_{—}}₁≦1.340×10⁻³, (11)
−1.893×10⁻³≦Sag_{0.3}_{_{—}}₂≦−8.383×10⁻³, (12)
−8.024×10⁻³≦Sag_{0.6}_{_{—}}₂≦−7.539×10⁻³, and (13)
−1.301×10⁻³≦Sag_{1.0}_{_{—}}₂≦−1.280×10⁻³, (14)
where, when an intersection of the optical axis and the lens surface, and a position corresponding to an effective diameter are represented as the effective diameter 0.0 and the effective diameter 1.0, respectively,
Sag_{0.3}_{_{—}}₁ is the first surface sag amount (mm) at the effective diameter 0.3,
Sag_{0.6}_{_{—}}₁ is the first surface sag amount (mm) at the effective diameter 0.6,
Sag_{1.0}_{_{—}}₁ is the first surface sag amount (mm) at the effective diameter 1.0,
Sag_{0.3}_{_{—}}₂ is the second surface sag amount (mm) at the effective diameter 0.3,
Sag_{0.6}_{_{—}}₂ is the second surface sag amount (mm) at the effective diameter 0.6, and
Sag_{1.0}_{_{—}}₂ is the second surface sag amount (mm) at the effective diameter 1.0.
